(19) United States
(12) Patent Application Publication
(10) Pub. No.: US 2016/0116153 A1
(43) Pub. Date: Apr. 28, 2016

(54) Lighted Swimwear

(71) Applicant: Reynaldo Suarez, Altamonte Springs, FL (US)

(72) Inventor: Reynaldo Suarez, Altamonte Springs, FL (US)

(21) Appl. No.: 14/881,594

(22) Filed: Oct. 13, 2015

Related U.S. Application Data
(60) Provisional application No. 62/068,221, filed on Oct. 24, 2014.

(51) Int. Cl. F21V 33/00; F21V 23/04; F21V 31/00; F21V 23/00; A41D 7/00; A41D 1/00

(52) U.S. Cl. CPC F21V 33/0008; A41D 7/005; A41D 1/002; F21V 31/005; F21V 23/003; F21V 23/04; F21Y 2101/02

(57) ABSTRACT

A lighted swimwear for providing illumination while swimming. The lighted swimwear preferably includes a bikini top and a bikini bottom, wherein both the bikini top and the bikini bottom each include a lighting assembly configured to illuminate the swimwear. The lighting assembly includes a battery, a power switch, a microprocessor, and a plurality of light emitting diodes. The plurality of light emitting diodes are affixed on an exterior side of both the bikini top and the bikini bottom. The microprocessor is configured to control the plurality of light emitting diodes in a way that they can be illuminated in desired patterns.

### CROSS REFERENCE TO RELATED APPLICATION

This application claims the benefit of U.S. Provisional Application No. 62/068,221 filed on Oct. 24, 2014. The above identified patent application is herein incorporated by reference in its entirety to provide continuity of disclosure.

### FIELD OF THE INVENTION

The present invention relates to swimwear. Specifically, the present invention relates to lighted swimwear, wherein a bikini top and a bikini bottom both include a lighting assembly having a plurality of light emitting diodes to illuminate the bikini top and the bikini bottom.

### BACKGROUND OF THE INVENTION

Swimming is often a favorite pastime during hot summer days. During periods of high heat, some people may prefer to swim in the evening when the temperatures are lower and when the sun is not as bright. However, swimming at night can be dangerous and it may be difficult to see within the pool without proper illumination. Further, if a person is swimming in a body of water in the evening, it can be difficult for others to locate the swimmer in the event the swimmer is in need of assistance.

Devices have been disclosed in the prior art that relate to clothing with lighting. These include devices that have been patented and published in patent application publications. Some clothing garments provide illuminated apparel, wherein the illumination means can be built into clothing, such as a swimsuit. Other garments provide an illumination system built into undergarments and lingerie in order to provide lighting onto the skin of an individual. These devices, however, fail to provide a waterproof lighting assembly affixed to swimwear, whereby the lighting assembly includes a microprocessor for lighting a plurality of light emitting diodes in desired pattern.

It is therefore submitted that the present invention is substantially divergent in design elements from the prior art, and consequently it is clear that there is a need in the art for an improvement to lighted swimwear devices. In this regard, the instant invention substantially fulfills these needs.

### SUMMARY OF THE INVENTION

In view of the foregoing disadvantages inherent in the known types of lighted swimwear now present in the prior art, the present invention provides a lighted swimwear wherein the same can be utilized for illuminating a swimmer's body so that the swimmer is more easily visible.

It is therefore an object of the invention to provide a new and improved lighted swimwear that has all of the advantages of the prior art and none of the disadvantages.

Another object of the present invention is to provide a new and improved lighted swimwear having a bikini top and a bikini bottom.

Yet another object of the present invention is to provide a new and improved lighted swimwear, wherein the bikini top and the bikini bottom each include a lighting assembly having a plurality of light emitting diodes affixed to an exterior side of the bikini top and the bikini bottom.

Still yet another object of the present invention is to provide a new and improved lighted swimwear, wherein said lighting assembly further includes a battery, a power switch, and a microprocessor.

A further object of the present invention is to provide a new and improved lighted swimwear, wherein said microprocessor is configured to illuminate a plurality of light emitting diodes in any of various predetermined patterns.

Still yet another object of the present invention is to provide a new and improved lighted swimwear wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of an embodiment of the lighted swimwear.

FIG. 2 shows a rear view of an embodiment of the lighted swimwear.

FIG. 3 shows a schematic diagram of the lighted swimwear.

### DETAILED DESCRIPTION OF THE INVENTION

Reference is made herein to the attached drawings. Like reference numerals are used throughout the drawings to depict like or similar elements of the lighted swimwear. For the purposes of presenting a brief and clear description of the present invention, the preferred embodiment will be discussed as used for helping to provide a waterproof illumination device for a user while swimming and wearing swimwear. The figures are intended for representative purposes only and should not be considered to be limiting in any respect.

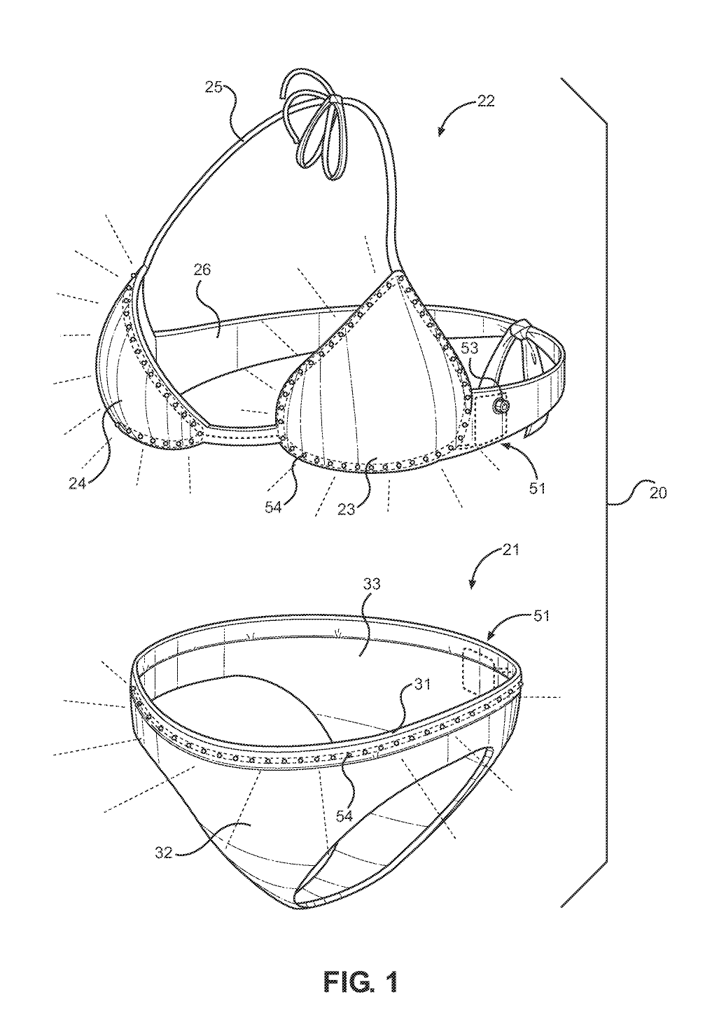

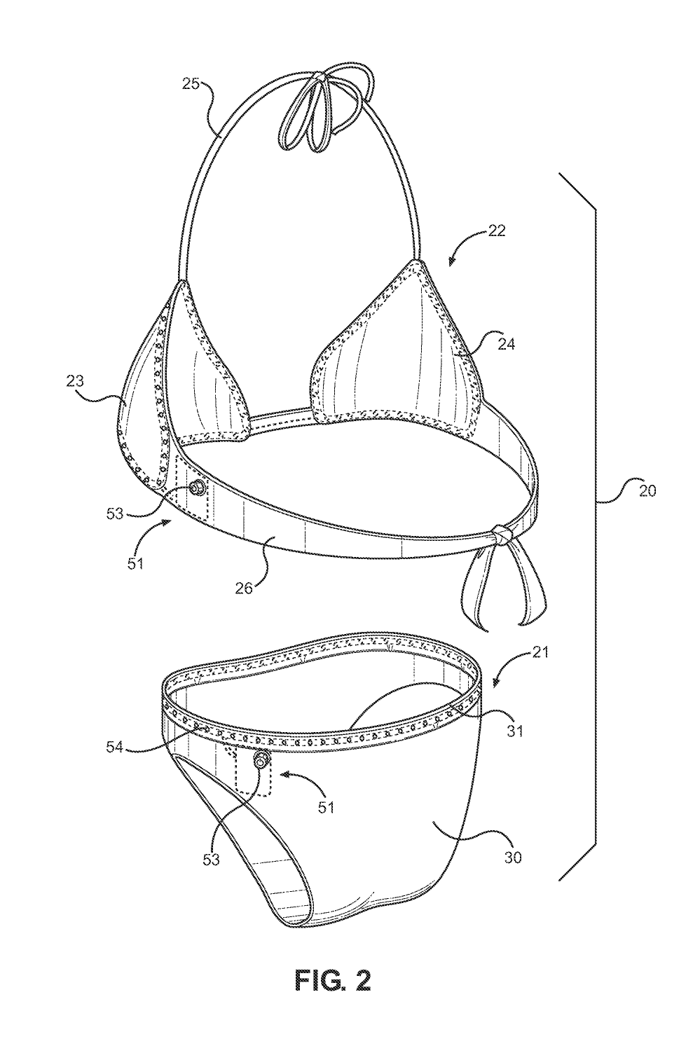

Referring now to FIGS. 1 and 2, there are shown a front perspective view and a rear perspective view of the lighted swimwear, respectively. In the illustrated embodiment, the lighted swimwear 20 comprises a bikini bottom 21 and a bikini top 22, wherein both the bikini bottom 21 and the bikini top 22 each include lighting assemblies 51 thereon wherein the lighting assemblies 51 are adapted to illuminate in one or more predetermined patterns or sequences.

The bikini bottom 21 comprises a waistband 31, a front portion 32, a rear portion 33, and a pair of leg openings so as to resemble a conventional bikini bottom 21. The bikini bottom 21 is composed of a nylon fabric material, however other suitable materials are contemplated. In addition, the bikini bottom 21 can include a variety of different shapes and sizes, including briefs, hipsters, bikinis, and thongs. These variations and alterations of the inventive embodiment described herein are deemed within the scope of the present disclosure.

In some embodiments, the waistband 31 can be made of elastic to allow for the bikini bottom 21 to be form fitting. However, various other suitable materials are contemplated. Alternatively, other embodiments may be of the string bikini variation, wherein the waistband 31 comprises of string like material. It is not desired at this time to limit the material used for composing the waistband 31.

A lighting assembly 51 is integrated into the bikini bottom 21, wherein the lighting assembly 51 comprises a plurality of lights 54, a microprocessor, and a power switch. In the illustrated embodiment, the lights 54 are disposed around the waistband 31 of the bikini bottom 21 so as to illuminate the front, rear, and sides of the user. The lighting assembly 51 is preferably enclosed within a waterproof covering, so as to protect the electrical components and to ensure the proper functioning to the lighting assembly 51. In alternate embodiments, the lights 54 may be disposed in various configurations on the bikini bottom 21.

The bikini top 22 comprises a first cup 23 and a second cup 24, wherein each cup 23, 24 is configured to cover a user's breast. The shape and size of each cup 23, 24 are preferably triangular in shape, however, other sizes and shapes suitable for covering a user's breasts are contemplated. As illustrated, the first cup 23 and the second cup 24 are adjoined via a back strap 26 that is configured to wrap around a user's back and a neck strap 25 that is configured to wrap around a user's neck. Preferably, the back strap 26 and neck strap 25 are adjustable so that the user can removably secure the bikini top 22 in position and secure it to a desired tightness. It is also contemplated that the bikini top 22 is preferably composed of nylon fabric, however, other material suitable for water wear are alternatively used in other embodiments.

Similar to the bikini bottom 21, the bikini top 22 comprises a lighting assembly 51 having a microprocessor, a power switch 53, and a plurality of lights 54. In the illustrated embodiment, the lights 54 are disposed on the perimeter of the cups 23, 24 so as to illuminate the front portion or chest of the user. In this way, both the upper and lower body of the user is illuminated. The lighting assembly 51 is integrated into the bikini top 22 and is preferably enclosed within a waterproof covering so as to prevent the lighting assembly 51 from getting wet. Preferably, the LEDs and other components are composed of a waterproof material.

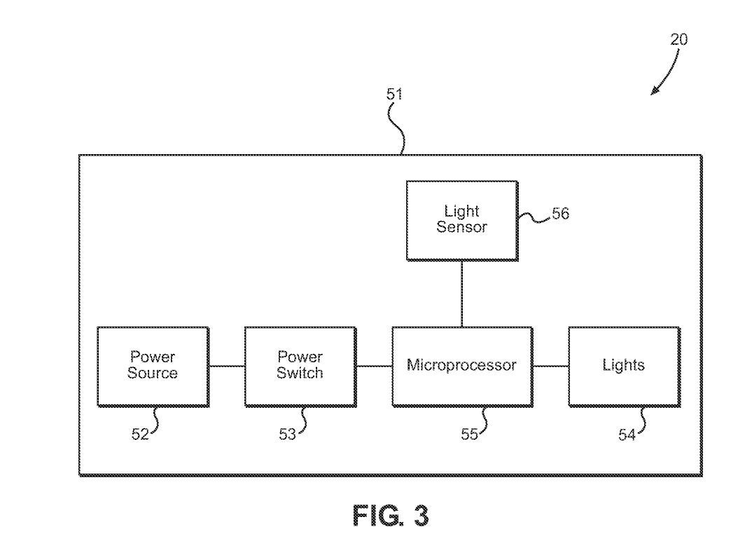

Referring now to FIG. 3, there is shown a schematic diagram of the lighting assembly 51 of the lighted swimwear 20. As aforementioned, the bikini bottom and the bikini top each further include a lighting assembly 51. Each lighting assembly 51 includes a power source 52, a power switch 53, a microprocessor 55, and a plurality of lights to illuminate the bikini bottom 21 and the bikini top 22. The lights 54 may comprise LEDs, electroluminescent wires (EL wires), or any of various other light sources. The lights 54 are activated by the power switch 53, which completes a circuit from the power source 52 to the lights 54. The power switch 53 is preferably a depressible activation button, however other suitable switches such as rocker switches and toggle switches are also appropriate. The power switch 53 is preferably mounted on an exterior portion of the bikini top and bikini bottom so that a user can activate and deactivate the lighting assembly 51. The power switch 53 can also be used in order to alternate between various illumination patterns for the lights 54.

The lights 54 are also waterproof so that they are operable while a user is in or near a swimming pool or other body of water. The lights 54 are the preferably LEDs as LEDs are energy efficient, emit low intensity light, and general a minimal amount of heat. However, as previously stated, other types of light sources may be used in alternate embodiments, such as EL wires, among others. The lights 54 are preferably spaced at fixed intervals on the bikini top and bikini bottom so as to evenly illuminate the swimwear. Further, the lights 54 may comprise any of various colors so as to provide a desired color for illumination.

The microprocessor 55 is configured to control the lights 54 by varying and modulating the electric current through the lights. In this way, the microprocessor 55 allows a user to customize patterns for illuminations. The microprocessor is configured to allow the plurality of lights 54 to be illuminated in desired patterns. In some embodiments, the lights are adapted to provide constant illumination. In other embodiments, the lights flash on and off. In additional embodiments, the lights may illuminate randomly so as to provide a twinkling appearance. Further, the lights may illuminate sequentially. Although a microprocessor 55 is disclosed within the present disclosure, other means are readily apparent to those of ordinary skill within this art. These modifications and alterations are also deemed within the scope of the present invention.

In some embodiments, the lighting assembly 51 further comprises a light sensor 56 adapted to detect ambient light. The light sensor 56 is operably connected to the microprocessor 55 so as to communicate therewith. In periods of bright light, the light sensor 56 detects the light and causes the lights 54 to be powered off. When ambient light falls below a predetermined level, such as at night, the light sensor 56 causes the lights 54 to automatically illuminate so that the user does not have to operate a power switch 53.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A lighted swimwear, comprising:
a bikini top comprising a lighting assembly configured to illuminate said bikini top;
said lighting assembly comprises a plurality of lights affixed on said bikini top, a microprocessor, and a power switch, wherein said microprocessor is adapted to illuminate said plurality of lights in a predetermined pattern or sequence.

2) The lighted swimwear of claim 1, wherein said bikini top comprises a pair of cups disposed on a back strap adapted to encircle a user's torso, and further comprising a neck strap that extends upward from said pair of cups and that is adapted to be secured around a user's neck.

3) The lighted swimwear of claim 2, wherein said plurality of lights are disposed on a perimeter of said pair of cups.

4) The lighted swimwear of claim 1, wherein said plurality of lights are disposed within a waterproof covering.

5) The lighted swimwear of claim 1, further comprising a light sensor adapted to automatically illuminate said plurality of lights during periods of low light.

6) A lighted swimwear, comprising:
a bikini bottom comprising a lighting assembly configured to illuminate said bikini bottom;
said lighting assembly comprises a plurality of lights affixed on said bikini bottom, a microprocessor, and a power switch, wherein said microprocessor is adapted to illuminate said plurality of lights in a predetermined pattern or sequence.

7) The lighted swimwear of claim 6, wherein said bikini bottom comprises a waistband, a front portion, a rear portion, and a pair of leg openings.

8) The lighted swimwear of claim 7, wherein said plurality of lights is disposed on said waistband of said bikini bottom.

9) The lighted swimwear of claim 6, wherein said plurality of lights are disposed within a waterproof covering.
